(19) United States
(12) Patent Application Publication
(10) Pub. No.: US 2006/0187031 A1
(43) Pub. Date: Aug. 24, 2006

(54) Selecting RFID tags using memory-mapped parameters

(75) Inventors: Vincent C. Moretti, Kenmore, WA (US); William T. Colleran, Seattle, WA (US); Christopher J. Diorio, Shoreline, WA (US)

Correspondence Address: MERCHANT & GOULD PC, P.O. BOX 2903, MINNEAPOLIS, MN, 55402-0903, US

(73) Assignee: IMPINJ. Inc., Seattle, WA (US)

(21) Appl. No.: 11/217,616

(22) Filed: Aug. 31, 2005

Related U.S. Application Data
(60) Provisional application No. 60/651,116, filed on Feb. 7, 2005.

(51) Int. Cl. G08B 1/08; G05B 19/00; H04Q 5/22; G08B 13/14; G08C 19/16

(52) U.S. Cl. 340/539.22; 340/572.8; 340/10.1; 340/5.1; 340/870.01

(57) ABSTRACT

Radio frequency identification (RFID) tags are associated with sensors. Sensor data from a sensor is internally associated with a mask address, such as that of a memory. The tags receive commands by a reader, which can include selection commands. The selection commands can be for selecting according to the sensor data, by invoking the mask address. The selection commands can be further associated with a mask value, calling for setting a selection flag only by those tags whose sensor data meets a selection condition relative to the mask value. Therefore the reader can select a sub-population of tags from a larger population based on sensor data.

### RELATED APPLICATIONS

This application claims the benefit of U.S. Provisional Application Ser. No. 60/651,116 filed on Feb. 7, 2005, which is hereby claimed under 35 U.S.C. §119(e). The referenced Provisional Application and U.S. Pat. No. 6,720,866 to Sorells et al. are incorporated herein by reference.

### TECHNICAL FIELD

The present invention relates to Radio Frequency IDentification (RFID) devices, and more particularly, to RFID readers employing commands to select sub-populations of RFID tags.

### BACKGROUND

RFID systems typically include RFID tags and RFID readers (the latter are also known as RFID reader/writers or RFID interrogators). RFID systems can be used in many ways for locating and identifying objects to which the tags are attached. RFID systems are particularly useful in product-related and service-related industries for tracking large numbers of objects being processed, inventoried, or handled. In such cases, an RFID tag is usually attached to an individual item, or to its package.

In principle, RFID techniques entail using an RFID reader to interrogate one or more RFID tags. The reader transmitting a Radio Frequency (RF) wave performs the interrogation. A tag that senses the interrogating RF wave responds by transmitting back another RF wave. The tag generates the transmitted back RF wave either originally, or by reflecting back a portion of the interrogating RF wave in a process known as backscatter. Backscatter may take place in a number of ways.

The reflected back RF wave may further encode data stored internally in the tag, such as a number. The response is demodulated and decoded by the reader, which thereby identifies, counts, or otherwise interacts with the associated item. The decoded data can denote a serial number, a price, a date, a destination, other attribute(s), any combination of attributes, and so on.

### SUMMARY

This disclosure facilitates selection of a sub-population of tags within a population of tags in a reader's field of view, based directly on sensor data collected by sensors associated with the tags. Accordingly, the disclosure provides for selection of tags based on parameters such as environmental data, telemetry data, and the like.

In some embodiments, RFID tags are associated with sensors. Sensor data from a sensor is internally associated with a mask address, such as that of a memory. The tags receive commands by a reader, which can include selection commands. The selection commands can be for selecting according to the sensor data, by invoking the mask address. The selection commands can be further associated with a mask value, calling for setting a selection flag only by those tags whose sensor data meets a selection condition relative to the mask value. Therefore the reader can select a sub-population of tags from a larger population based on sensor data.

While example embodiments are shown with passive RFID tags, the principles disclosed herein may be implemented with other types of tags as well, including active tags. Thus, the invention is not limited to the illustrated examples.

### BRIEF DESCRIPTION OF THE DRAWINGS

Non-limiting and non-exhaustive embodiments are described with reference to the following drawings.

FIG. 1 is a diagram of an example RFID system including an RFID reader communicating with a plurality of RFID tags in its field of view;

FIG. 2 illustrates the RFID system of FIG. 1 with a sub-population of the RFID tags selected;

FIG. 3 illustrates the RFID system of FIG. 1, where a tag that has been singulated is being accessed;

FIG. 4 is a conceptual diagram for explaining the half-duplex mode of communication between the components of the RFID system of FIG. 1, during operation;

FIG. 5A is a diagram of an RFID tag such as one of the tags of FIG. 1;

FIG. 5B is a diagram of an RFID tag including a sensor integrated with the core RFID circuitry;

FIG. 5C is a diagram of an RFID tag including a sensor on the same tag as the core RFID circuitry;

FIG. 5D is a diagram of an RFID tag coupled to a sensor that is located off the tag;

FIG. 6 illustrates an embodiment of a block diagram for an electrical circuit that may be employed in an RFID tag such as the RFID tag of FIG. 5C;

FIGS. 7A and 7B illustrate two versions of the electrical circuit of FIG. 6 emphasizing signal flow in receive and transmit operational modes, respectively;

FIG. 8 illustrates a partial block diagram of the circuit of FIG. 6 where the sensor address is mapped outside physical memory;

FIG. 9 illustrates a partial block diagram of the circuit of FIG. 6 where the sensor address is mapped into physical memory;

FIG. 10 illustrates an embodiment of sensor data mapped into physical memory emphasizing memory addresses by function;

FIGS. 11A and 11B illustrate two possible embodiments of the major functional blocks of an RFID reader such as the RFID reader shown in FIG. 1;

FIG. 12A illustrates an RFID reader transmitting a command that includes a mask address and mask value to an RFID tag;

FIG. 12B illustrates the mask value being compared to sensor data located at the mask address in tag memory;

FIGS. 13A and 13B illustrate sensor data representation on an example numeric scale and an example thermometer scale, respectively;

FIGS. 14A and 14B show examples of mask matching and mask not-matching based on comparing the mask value with sensor data mapped into memory;

FIG. 14C shows an example of comparing a mask value using the thermometer scale of FIG. 13B;

FIG. 15 shows a flowchart for a process of actions performed by an RFID tag during selection according to one embodiment;

FIG. 16 is a partial flowchart illustrating a manner for comparing sensor data to a mask value in the process of FIG. 15; and

FIG. 17 is a partial flowchart illustrating another manner for comparing sensor data to a mask value in the process of FIG. 15.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context clearly dictates otherwise. The meanings identified below are not intended to limit the terms, but merely provide illustrative examples for the terms. The meaning of “a,” “an,” and “the” includes plural reference, the meaning of “in” includes “in” and “on.” The term “connected” means a direct electrical connection between the items connected, without any intermediate devices. The term “coupled” means either a direct electrical connection between the items connected or an indirect connection through one or more passive or active intermediary devices. The term “circuit” means either a single component or a multiplicity of components, either active and/or passive, that are coupled together to provide a desired function. The term “signal” means at least one current, voltage, charge, temperature, data, or other measurable quantity. The terms “RFID reader” and “RFID tag” are used interchangeably with the terms “reader” and “tag”, respectively, throughout the text and claims. The terms “command size” and “command length” are used interchangeably throughout the text and claims. While this description is mostly in terms of commands, that is only intended as an example, and it is intended to apply also to more generalized words.

Briefly, this disclosure is about tags with associated sensors. Data from the sensors is associating with a sensor mask address, such as one used for accessing a memory of the tag. When a wave is received, a command is decoded from it, which is associated with an indicated mask address and an indicated mask value. If the indicated mask address matches the sensor mask address, then the indicated mask value is compared for whether it matches the sensor data, and a selection flag is set accordingly. The mask value can be transmitted, or be stored, etc.

The invention is now described in more detail.

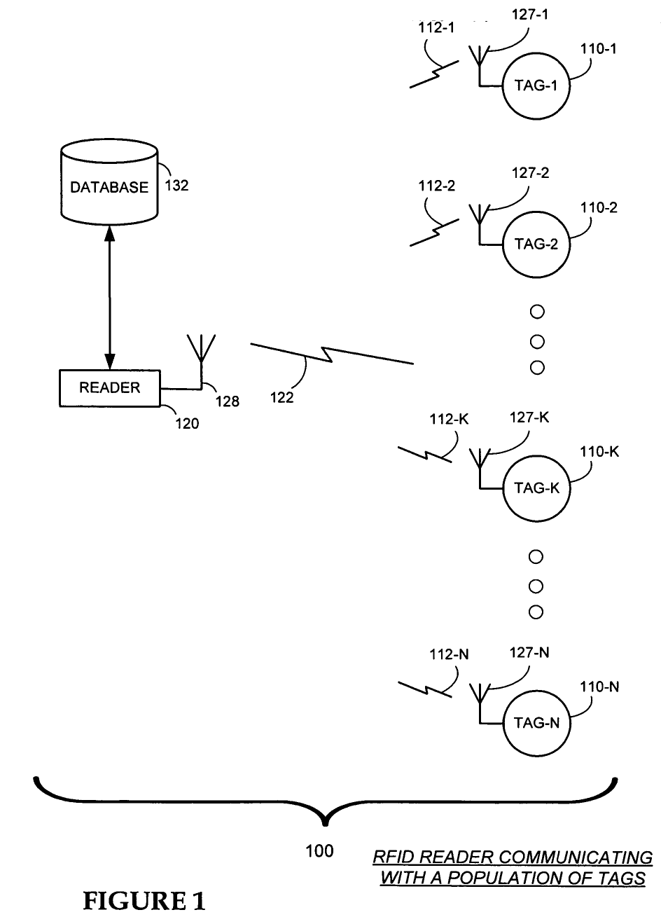

FIG. 1 is a diagram of an example RFID system 100, incorporating aspects of the invention. System 100 includes an RFID reader 120 and N RFID tags 110-1, 110-2, . . . 110-K, . . . , 110-N in the vicinity of each other and of reader 120.

RFID reader 120 has an antenna 128, and may be in communication with database 132. Reader 120 transmits an interrogating Radio Frequency (RF) wave 122, which can be perceived by tags 110-1, 110-2, . . . , 110-K, . . . , 110-N.

RFID tags 110-X (X here stands for 1, 2, . . . , K, . . . , N) can be passive tags or active tags, i.e. tags having their own power source. Where tags 110-X are passive tags, they are powered from wave 122.

Each tag 110-X includes an antenna 127-X. Upon sensing interrogating RF wave 122, each tag 110-X may generate a wave 112-X in response. RFID reader 120 senses and interprets waves 112-X.

In FIG. 1, as in other figures, interrogating RF wave 122 is shown as larger than waves 112-X. This is to signify that interrogating RF wave 122 typically has a higher intensity than response wave 112-X.

Reader 120 and tag 110-X thus exchange data via waves 122 and 112-X. In a session of such an exchange, each encodes, modulates, and transmits data to the other, and each receives, demodulates, and decodes data from the other. The data is modulated onto, and decoded from, RF waveforms, as will be seen in more detail below.

Encoding the data can be performed in a number of different ways. For example, protocols are devised to communicate in terms of symbols, also called RFID symbols. A symbol for communicating can be a preamble, a null symbol, a symbol 0, a symbol 1, and so on. Further symbols can be implemented for ultimately exchanging binary data, such as “0” and “1”, if that is desired.

In addition, groups of these bits and/or symbols are named according to their function. For example, it is customary to refer to such groups as “commands”, “data”, “payload”, “handle”, and so on.

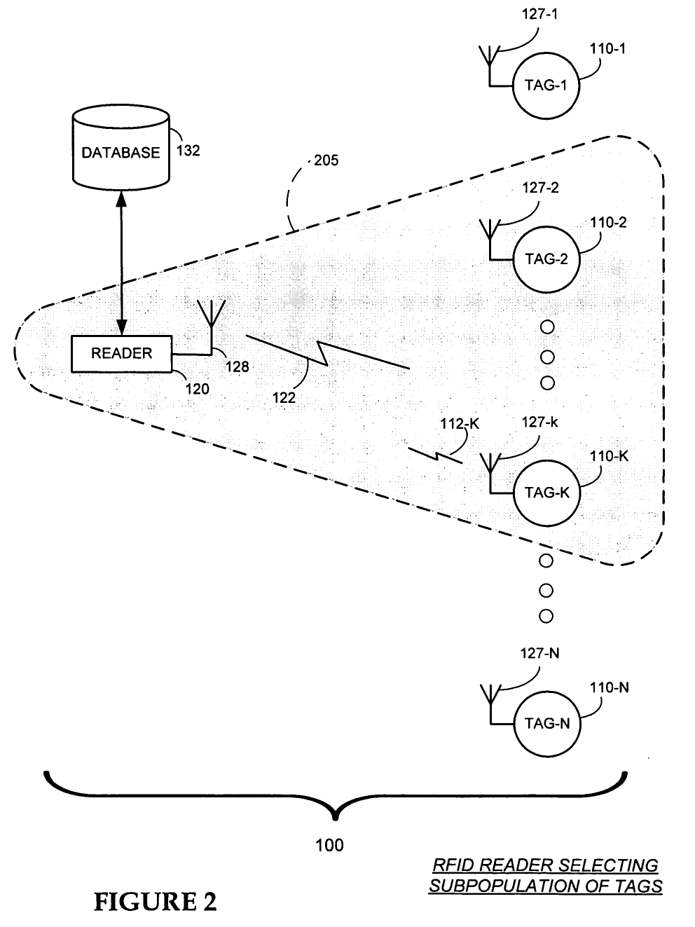

FIG. 2 illustrates the RFID system 100, which was first presented in FIG. 1. In addition, a sub-population of RFID tags comprising tags 110-2 through 110-K have been selected by reader 120, as shown by relationship 205. This selection enables reader 120 to singulate and access an RFID tag, such as tag 110-K, from among a smaller group of tags based on predetermined criteria.

In one embodiment, the criteria may be a flag being set by the tag in response to a comparison of a mask value received from the reader with sensor data stored at a mask address.

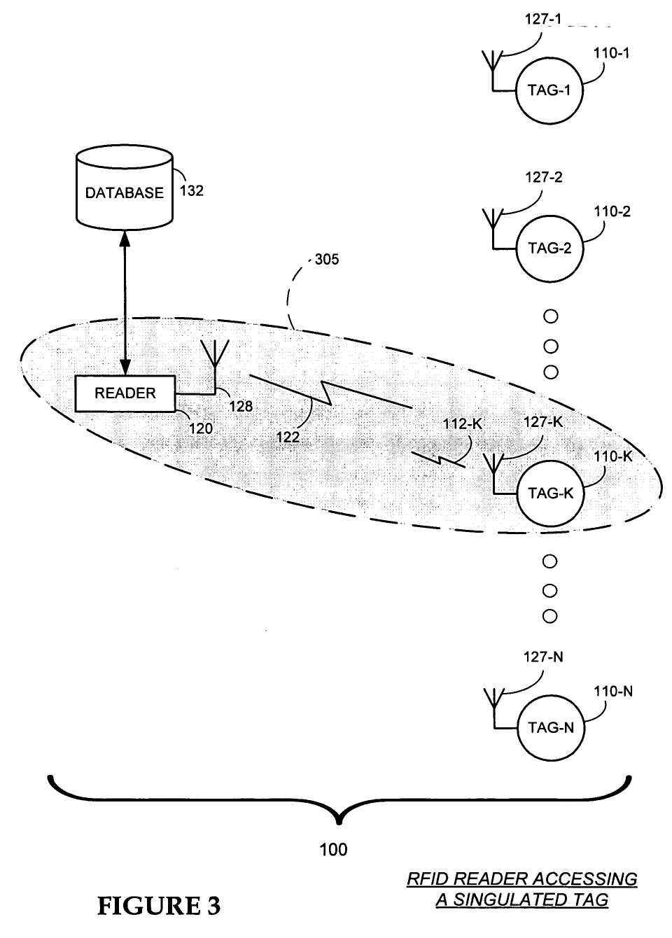

FIG. 3 illustrates the RFID system 100, which was first presented in FIG. 1. In addition, RFID tag 10-K has been singulated by reader 120, as shown by relationship 305. This singulation has caused all tags 110-X except tag 110-K to not transmit, so that reader 120 and singulated tag 110-K can exchange data without interference and reader 120 can access tag 110-K.

Reader 120 has accomplished singulation by first issuing appropriate commands, which have caused tags 110-X to transition to appropriate internal states. In this example, at least tag 110-K is in a state where it can receive an access-type command, while the remaining tags are in states where generally they do not respond or take action, until reader 120 and singulated tag 110-K complete their exchanges.

The term singulation, as used for the present document, generally means a process for distinguishing a tag from other tags. As such, singulation may be unnecessary when a single reader is addressing a single tag, or where there is no interference from, or concern about any other RFID components such as other RFID tags. The term singulation, as used here, may by coincidence be functionally the same as a specific term “singulation”, which means a process of a reader that can be performed with many or even a single tag.

The term accessing, as used for the present document, generally means a process for retrieving information stored at the tag and/or causing information stored at the tag to be modified. This may include receiving an identifier symbol, user-specified data, and the like, from the tag, as well as storing a new identifier symbol etc. at the tag. Accessing may further include causing one or more operational parameters of the tag to be changed such as a security mechanism.

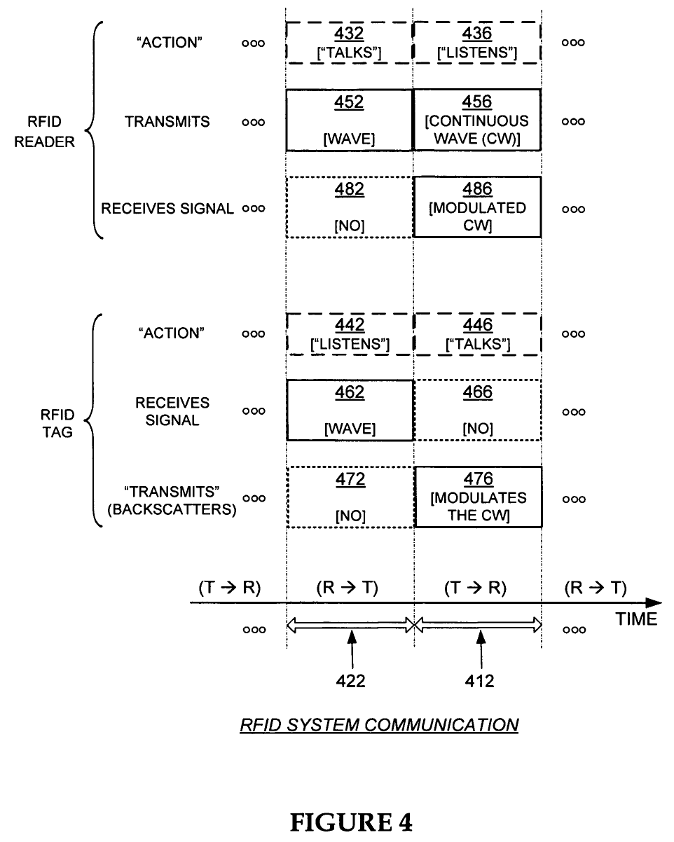

FIG. 4 is a conceptual diagram 400 for explaining the half-duplex mode of communication between the components of the RFID system of FIG. 1, especially when tag 110-K is implemented as a passive tag. The explanation is made with reference to a TIME axis, and also to a human metaphor of “talking” and “listening”. The actual technical implementations for “talking” and “listening” are now described.

RFID reader 120 and RFID tag 110-K talk and listen to each other by taking turns. As seen on axis TIME, when reader 120 talks to tag 110-K the communication is designated as “R→T”, and when tag 110-K talks to reader 120 the communication is designated as “T→R”. Along the TIME axis, a sample R→T session occurs during a time interval 422, and a following sample T→R session occurs during a time interval 412. Of course intervals 422, 412 can be of different durations—here the durations are shown approximately equal only for purposes of illustration.

According to blocks 432 and 436, RFID reader 120 talks during interval 422, and listens during interval 412. According to blocks 442 and 446, RFID tag 110-K listens while reader 120 talks (during interval 422), and talks while reader 120 listens (during interval 412).

In terms of actual technical behavior, during interval 422, reader 120 talks to tag 110-K as follows. According to block 452, reader 120 transmits wave 122, which was first described in FIG. 1. At the same time, according to block 462, tag 110-K receives wave 122 and processes it. Meanwhile, according to block 472, tag 110-K does not backscatter with its antenna, and according to block 482, reader 120 has no wave to receive from tag 110-K.

During interval 412, tag 110-K talks to reader 120 as follows. According to block 456, reader 120 transmits a Continuous Wave (CW), which can be thought of as a carrier signal that ideally encodes no information. As discussed before, this carrier signal serves both to be harvested by tag 110-K for its own internal power needs, and also as a wave that tag 110-K can backscatter. Indeed, during interval 412, according to block 466, tag 110-K does not receive a signal for processing. Instead, according to block 476, tag 110-K modulates the CW emitted according to block 456, so as to generate backscatter wave 112. Concurrently, according to block 486, reader 120 receives backscatter wave 112 and processes it.

The components of the RFID system of FIG. 1 may communicate with each other in any number of modes. One such mode is called half-duplex, as described previously. Another such mode is called full duplex, wherein reader and tag transmit and receive simultaneously.

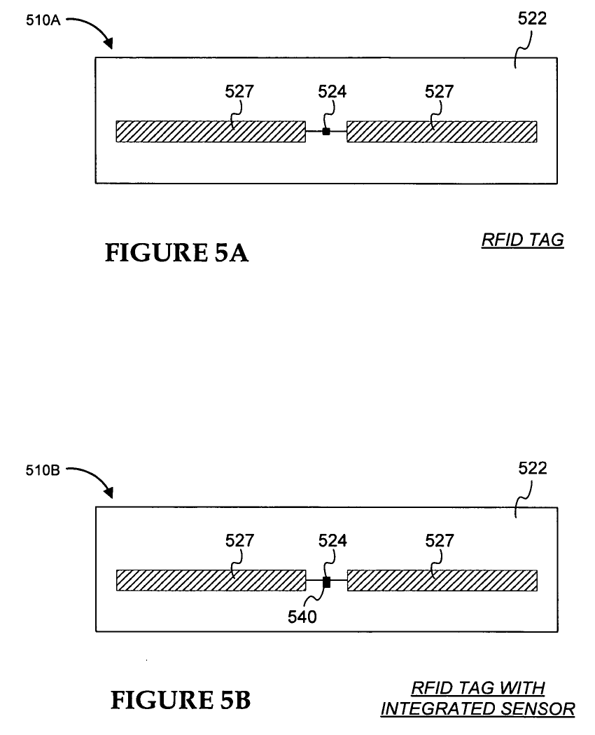

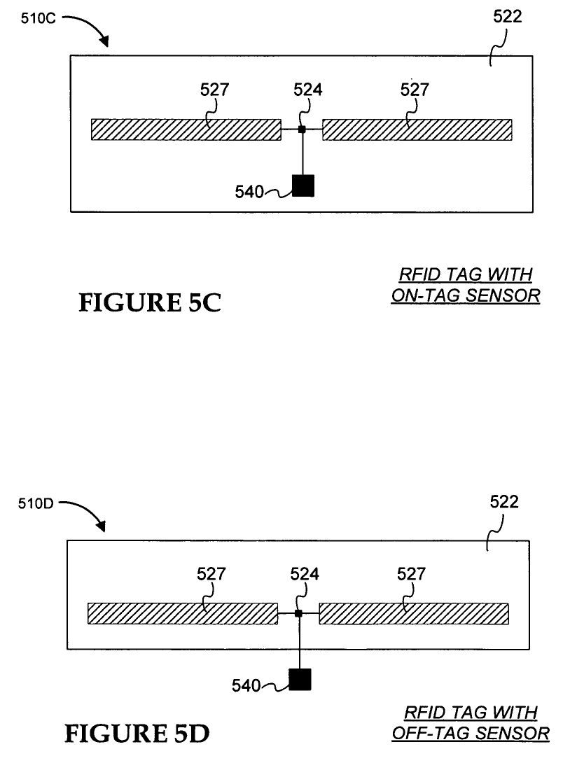

FIG. 5A is a diagram of RFID tag 510A. Tag 510A is implemented as a passive tag, meaning it does not have its own power source. Much of what is described in this document, however, applies also to active tags.

Tag 510A is formed on a substantially planar inlay 522, which can be made in many ways known in the art. Tag 510A also includes two antenna segments 527, which are usually flat and attached to inlay 522. Antenna segments 527 are shown here forming a dipole, but many other embodiments using any number of antenna segments are possible.

Tag 510A also includes an electrical circuit, which is preferably implemented in an integrated circuit (IC) 524. IC 524 is also arranged on inlay 522, and electrically coupled to antenna segments 527. Only one method of coupling is shown, while many are possible.

In operation, a signal is received by antenna segments 527, and communicated to IC 524. IC 524 both harvests power, and decides how to reply, if at all. If it has decided to reply, IC 524 modulates the reflectance of antenna segments 527, which generates the backscatter from a wave transmitted by the reader. Coupling together and uncoupling antenna segments 527 can modulate the reflectance, as can a variety of other means.

In the embodiment of FIG. 510A, antenna segments 527 are separate from IC 524. In other embodiments, antenna segments may alternately be formed on IC 524, and so on.

FIG. 5B is a diagram of composite RFID tag 510B with a sensor block 540 integrated on the RFID core circuitry. Parts of RFID tag 510B that are similarly numbered as RFID tag 510A of FIG. 5A are arranged to function in a likewise manner.

Sensor block 540 may be implemented in any way known in the art and may include sensing circuitry as well as processing circuitry. Sensor block 540 may sense a parameter associated with a modulated wave received by the tag or a plurality of modulated waves received in a predetermined time period. Sensor block 540 may also sense telemetry information associated with at least one of the tag and an object that is attached to the tag or environmental information associated with at least one of a temperature, a pressure, a humidity, a light intensity, and a pH level. Sensor block 540 may further sense physical information associated with at least one of a velocity, an acceleration, and a power level associated with the RFID tag.

FIG. 5C is a diagram of composite RFID tag 510C with sensor block 540 on the tag but separate from the RFID core circuitry (e.g. from circuit 524). Parts of RFID tag 510C that are similarly numbered as RFID tag 510B of FIG. 5B including sensor block 540 are arranged to function in a likewise manner.

FIG. 5D is a diagram of composite RFID tag 510D with sensor block 540 off the tag. Parts of RFID tag 510D that are similarly numbered as RFID tag 510B of FIG. 5B including sensor block 540 are arranged to function in a likewise manner.

Sensor block 540 may be attached to an object that the tag is attached to. In another embodiment, sensor block 540 may be in a sensor device that is physically separate from the tag. Sensor block 540 may even be integrated into an RFID reader.

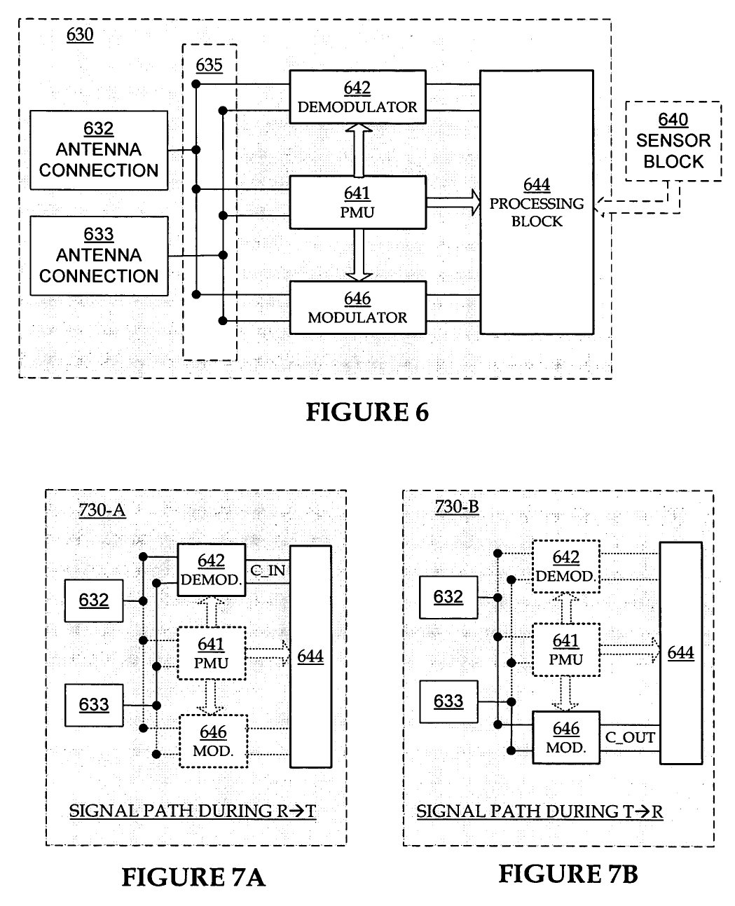

FIG. 6 is a block diagram of an electrical circuit 630. Circuit 630 may be formed in an IC of an RFID tag, such as IC 524 of FIG. 5A. Circuit 630 has a number of main components that are described in this document. Circuit 630 may have a number of additional components from what is shown and described, or different components, depending on the exact implementation.

Circuit 630 includes at least two antenna connections 632, 633, which are suitable for coupling to antenna segments (not shown in FIG. 6). Antenna connections 632, 633 may be made in any suitable way, such as pads and so on. In a number of embodiments more antenna connections are used, especially in embodiments where more antenna segments are used.

Circuit 630 includes a section 635. Section 635 may be implemented as shown, for example as a group of nodes for proper routing of signals. In some embodiments, section 635 may be implemented otherwise, for example to include a receive/transmit switch that can route a signal, and so on.

Circuit 630 also includes a Power Management Unit (PMU) 641. PMU 641 may be implemented in any way known in the art, for harvesting raw RF power received via antenna connections 632, 633. In some embodiments, PMU 641 includes at least one rectifier, and so on.

In operation, an RF wave received via antenna connections 632, 633 is received by PMU 641, which in turn generates power for components of circuit 630. This is true for either or both of R→T sessions (when the received RF wave carries a signal) and T→R sessions (when the received RF wave carries no signal).

Circuit 630 additionally includes a demodulator 642. Demodulator 642 demodulates an RF signal received via antenna connections 632, 633. Demodulator 642 may be implemented in any way known in the art, for example including an attenuator stage, amplifier stage, and so on.

Circuit 630 further includes a processing block 644. Processing block 644 receives the demodulated signal from demodulator 642, and may perform operations. In addition, it may generate an output signal for transmission.

Processing block 644 may be implemented in any way known in the art. For example, processing block 644 may include a number of components, such as a processor, a memory, a decoder, an encoder, and so on.

Circuit 630 additionally includes a modulator 646. Modulator 646 modulates an output signal generated by processing block 644. The modulated signal is transmitted by driving antenna connections 632, 633, and therefore driving the load presented by the coupled antenna segments. Modulator 646 may be implemented in any way known in the art, for example including a driver stage, amplifier stage, and so on.

In one embodiment, demodulator 642 and modulator 646 may be combined in a single transceiver circuit. In another embodiment, modulator 646 may include a backscatter transmitter or an active transmitter.

In terms of processing a signal, circuit 630 operates differently during a R→T session and a T→R session. The treatment of a signal is described below.

FIG. 6 also shows optional sensor block 640. As mentioned previously, optional sensor block 640 may include one or more sensor devices that are arranged to measure environmental, physical, and telemetry parameters such as temperature, pressure, pH level, humidity, location, velocity, acceleration, and the like.

FIG. 7A shows version 730-A of circuit 630 of FIG. 6. Version 730-A shows the components of circuit 730 for a tag, further modified to emphasize a signal operation during a R→T session (receive mode of operation) during time interval 422 of FIG. 4. An RF wave is received from antenna connections 632, 633, a signal is demodulated from demodulator 642, and then input to processing block 644 as C_IN. In one embodiment according to the present invention, C_IN may include a received stream of symbols.

Version 730-A shows as relatively obscured those components that do not play a part in processing a signal during a R→T session. Indeed, PMU 641 may be active, but only in converting raw RF power. And modulator 646 generally does not transmit during a R→T session. Modulator 646 typically does not interact with the received RF wave significantly, either because switching action in section 635 of FIG. 6 decouples the modulator 646 from the RF wave, or by designing modulator 646 to have a suitable impedance, and so on.

While modulator 646 is typically inactive during a R→T session, it need not be always the case. For example, during a R→T session, modulator 646 could be active in other ways. For example, it could be adjusting its own parameters for operation in a future session.

FIG. 7B shows version 730-B of circuit 630 of FIG. 6. Version 730-B shows the components of circuit 630 for a tag, further modified to emphasize a signal operation during a T→R session during time interval 412 of FIG. 4. A signal is output from processing block 644 as C_OUT. In one embodiment according to the present invention, C_OUT may include a transmission stream of symbols. C_OUT is then modulated by modulator 646, and output as an RF wave via antenna connections 632, 633.

Version 730-B shows as relatively obscured those components that do not play a part in processing a signal during a T→R session. Indeed, PMU 641 may be active, but only in converting raw RF power. And demodulator 642 generally does not receive during a T→R session. Demodulator 642 typically does not interact with the transmitted RF wave, either because switching action in section 635 of FIG. 6 decouples the demodulator 642 from the RF wave, or by designing demodulator 642 to have a suitable impedance, and so on.

While demodulator 642 is typically inactive during a T→R session, it need not be always the case. For example, during a T→R session, demodulator 642 could be active in other ways. For example, it could be adjusting its own parameters for operation in a future session.

According to some embodiments, a radio frequency identification (RFID) tag includes an antenna that is arranged to receive a modulated wave, and a processor. The processor is arranged to associate with a mask address sensor data from one or more associated sensors.

The processor is further arranged to decode from the wave at least one command that is associated with a mask address and a mask value. In some embodiments, the command is a command for selecting a subpopulation of tags from a larger population. The mask address and/or mask value may also be decoded from the command, or be otherwise known to the tag.

If the mask address associated with the command is the same as the mask address associated with the sensor data, then the mask value associated with the command is compared with the sensor data, and a selection flag is set accordingly.

In some of these embodiments, the processor may decode a subsequent command from another wave received by the antenna and respond to the subsequent command depending on whether the selection flag is set.

In further embodiments, the tag may also include a memory. The addresses associated with the data of the one or more sensors may be mapped outside the memory, to a location of the memory, or in some combination thereof. The processor may input sensor data to the memory in response to the tag transitioning from a state of lacking power to a state of having power, in response to the command, in response to receiving a mask address corresponding to a sensor address, or in response to another event.

In yet other embodiments, a processed value may be generated based on at least the sensor data. The processed value may be derived by converting the sensor data into a representation on at least one of a thermometer scale, a numeric scale, a threshold scale, and the like. The processed value may also be generated based on a reference value. The reference value may be transmitted by the reader during a different transmission or during the same transmission as the mask value and mask address.

One or more of the sensor data, the processed value, and the reference value may be stored in the tag memory. The processor may, in some embodiments, decode the reference value from a wave received by the antenna, from a value stored in the memory, or from both. The processed value may be based on a difference between the sensor data and the reference value.

The sensor data may include a parameter of at least one of the modulated wave and a history of modulated waves, telemetry information associated with at least one of the tag and an object that is attached to the tag, environmental information associated with at least one of a temperature, a pressure, a humidity, a light intensity, and a pH level, or physical information associated with at least one of a velocity, an acceleration, and a power level associated with the RFID tag.

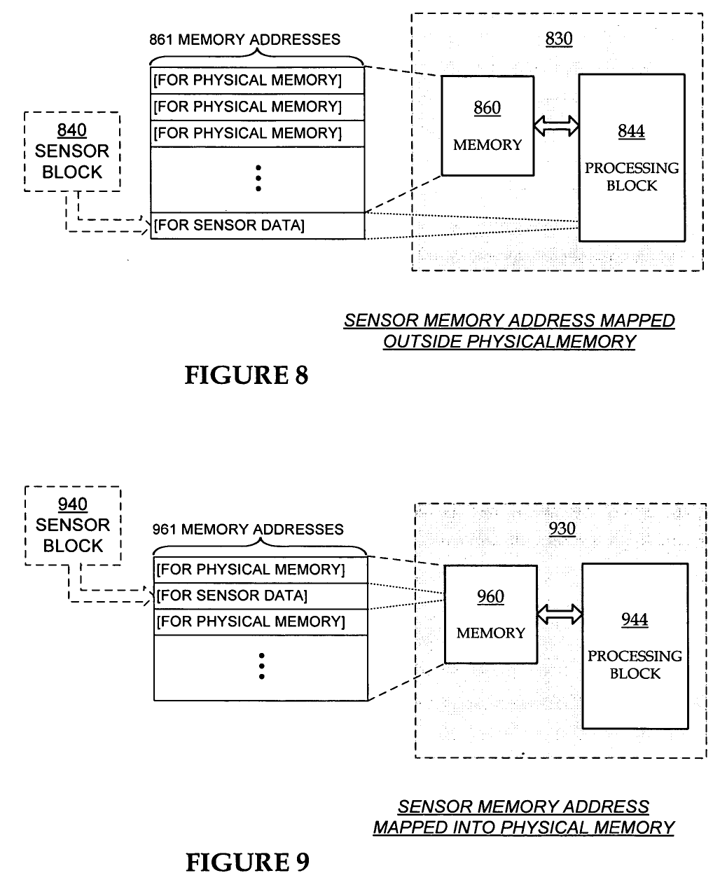

FIG. 8 illustrates partial block diagram 830 of circuit 630 of FIG. 6, where the sensor address is mapped outside physical memory. This means that the sensor data is associated with a mask address that does not really correspond to any actual physical memory. Advantageously, however, the system does not know the difference.

Partial block diagram 830 includes memory 860 and processing block 844. Processing block 844 may interact with optional sensor block 840, which is described in detail above in conjunction with FIG. 5B. The circuit of partial block diagram 830 may be included in an RFID tag such as tag 110-K of FIG. 1.

Memory 860 is arranged to store data associated with tag 110-K. Accordingly, memory 860 may be implemented from one or more nonvolatile memory cells, nonvolatile memory circuits, volatile memory cells, programmable logic arrays (PLAs), latches, registers, EPROMs, EEPROMs, and the like. In one embodiment, memory 860 may be implemented within processing block 844.

In one embodiment, memory 860 may include memory addresses 861. Some of memory addresses 861 may be reserved for physical memory and others for sensor data. Thus sensor memory addresses may be mapped outside physical memory addresses.

FIG. 9 illustrates partial block diagram 930 of circuit 630 of FIG. 6, where the sensor address is mapped into physical memory. This means that the sensor data is associated with a mask address that corresponds to a physical memory. Parts of partial block diagram 930 that are similarly numbered in partial block diagram 830 of FIG. 8 including optional sensor block 940 are arranged to function in a likewise manner.

Partial block diagram 930 includes memory 960 and processing block 944. Processing block 944 may interact with optional sensor block 940. Differently in partial block diagram 930, the memory address for sensor data is mapped into physical memory addresses within memory addresses 961.

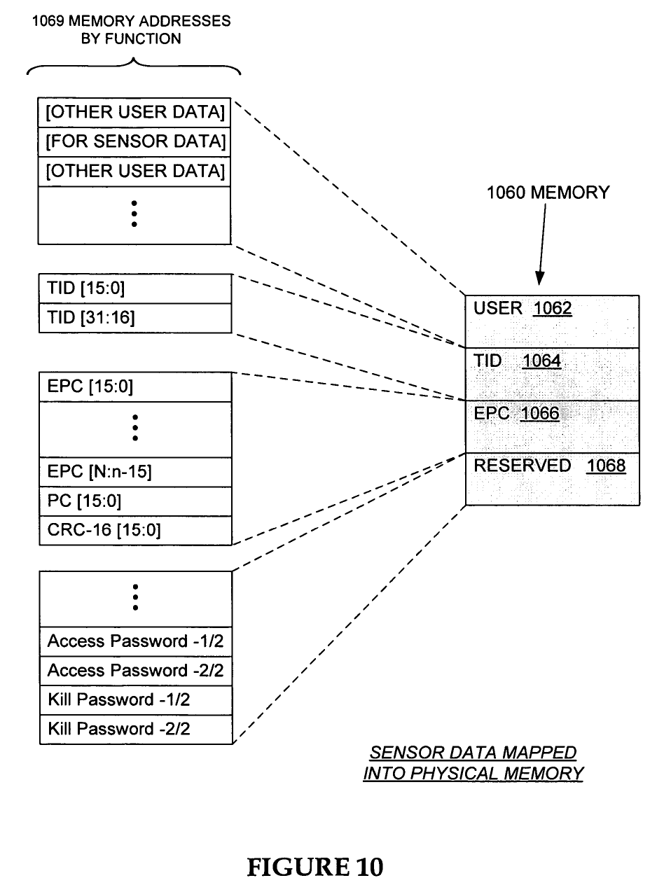

FIG. 10 illustrates an embodiment of sensor data mapped into physical memory emphasizing memory addresses by function.

The data stored in memory 1060 may include identification information associated with tag 110-K, information associated with an item the tag is attached to, communication parameters such as a password, externally delivered data, and the like. Data may be stored in memory 1060 during a production stage, or during an operation by processing block 844 of FIG. 8. Processing block 844 may access memory 1060 to store or retrieve one or more of a received command, password, and externally delivered data. Processing block 844 may also access memory 1060 to change its contents based on a command received from reader 120.

Tag memory 1060 may be partitioned into user-specific portion 1062, tag-identification portion 1064, object-identification portion (EPC) 1066, and reserved portion 1068. In other embodiments, memory 1060 may be partitioned in other ways with fewer or more portions, or not partitioned at all.

User-specific portion 1062 may be employed to store user-specified information including sensor data if the sensor data is mapped to user memory. Tag-identification portion (TID) 1064 may be employed to store information associated with a tag identifier, including sensor data if the sensor data is mapped to TID memory.

Object identification portion (EPC) memory 1066 can be arranged to store, as convenient, a protocol control (PC) parameter, an EPC code, and/or a CRC 16 (cyclic redundancy check) as shown in memory addresses 1069. EPC memory may also contain sensor data if the sensor data is mapped into EPC memory.

Reserved memory portion 1068 may be used to store system parameters such as passwords. Memory addresses 1069 illustrate two such example parameters, an access command password and a kill command password. Reserved memory may also contain sensor data if the sensor data is mapped into reserved memory.

Any portion of memory may store data in a single group, such as a single byte or word, or may store data in multiple groups or words (multiple bytes).

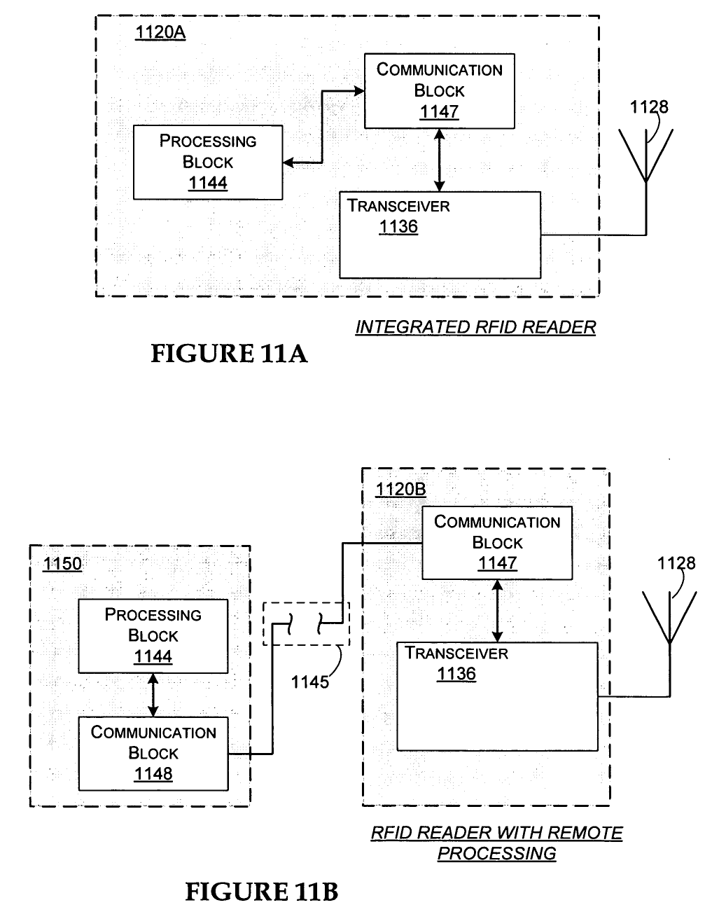

FIG. 11A illustrates the major functional blocks of RFID reader 1120A, which is one possible embodiment of the RFID reader 120 of FIG. 1. RFID reader 1120A is typically coupled to an antenna such as antenna 1128. The major functional blocks of RFID reader 1120A typically include processing block 1144, communication block 1147, and transceiver 1136.

Transceiver 1136 may include a modulator, a demodulator, and other circuitry as necessary. Transceiver 1136 is arranged to modulate an RF wave based on one or more signals from communication block 1147 and transmit said modulated RF wave via antenna 1128 to RFID tags within a field of view of RFID reader 1120A.

Transceiver 1136 is further arranged to demodulate an RF wave received from RFID tags within its field of view and provide said demodulated RF wave to processing block 1144 through communication block 1147. Transceiver 1136 may be implemented in any way known in the art and include circuits such as mixers, amplifiers, filters, and the like.

Communication block 1147 is arranged to provide communication between processing block 1144 and transceiver 1136, as well as between any other circuits within RFID reader 1120A. Communication block 1147 may condition, filter, amplify, and digitally process signals. In one embodiment, communication block 1147 may also be employed in communicating with external devices through various connections including, but not limited to, Ethernet, RF link, infrared link, a simple wire, and the like.

RFID reader 1120A further includes processing block 1144. Processing block 1144 may receive a demodulated signal from transceiver 1136 and perform operations. In addition, it may generate an output signal for transmission.

Processing block 1144 may be implemented in any way known in the art. For example, processing block 1144 may include a number of components, such as a processor, a memory, a decoder, an encoder, and so on.

RFID reader 1120A may include further blocks including a power supply, an input/output module, and the like. RFID reader 1120A may be powered from a wall outlet, a battery, and so on.

FIG. 11B illustrates the major functional blocks of RFID reader 1120B, which is another possible embodiment of the RFID reader 120 of FIG. 1. Parts of RFID reader 1120B that are similarly numbered to RFID reader 1120A of FIG. 11A are arranged to function in a likewise manner.

RFID reader 1120B, differently from RFID reader 1120A, does not include a processor block. Instead, RFID reader 1120B includes transceiver 1136 and communication block 1147, along with the coupled antenna 1128.

Processing block 1144 and communication block 1148 are housed in a different device designated by reference numeral 1150. Communications between processing block 1144 and transceiver 1136 may be provided by communication blocks 1147 and 1148, which are coupled through communication link 1145.

Communication link 1145 may include any type of connection known in the art such as a phone line link, an Ethernet link, an RF link, an infrared link, a simple wire, and the like. For example, device 1150 may be implemented as a network controller that is arranged to manage a number of RFID readers via wired and wireless links.

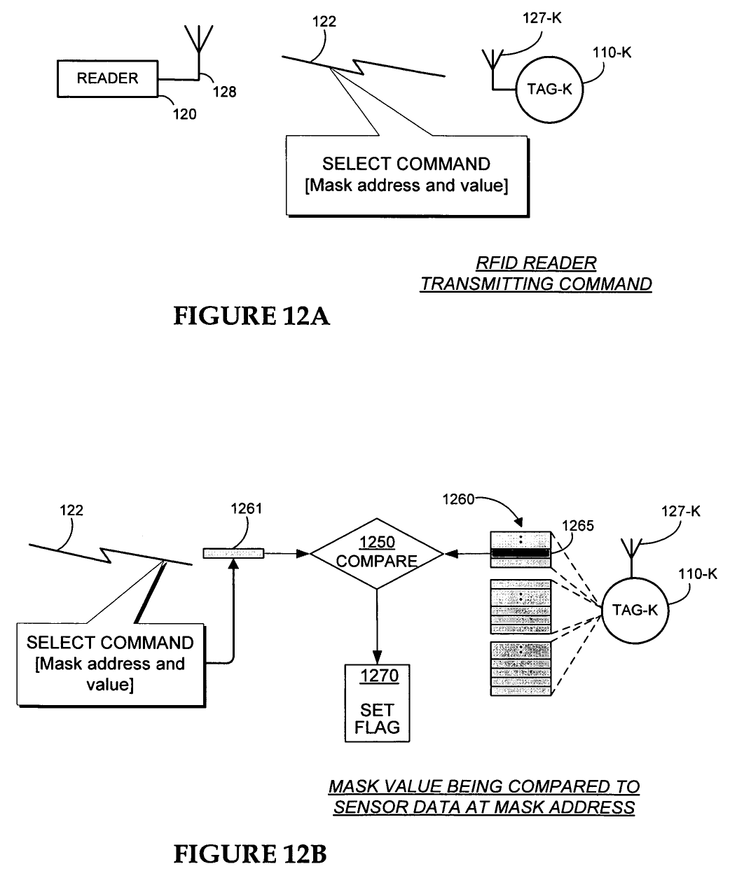

FIG. 12A illustrates an RFID reader transmitting a command that includes a mask address and mask value to an RFID tag.

As described previously, reader 120 transmits modulated wave 122 using its antenna 128. Modulated wave 122 may be encoded with one or more commands. Before singulating tags and accessing them, reader 120 may select a sub-population of tags for singulation using a Select command.

In one embodiment, the Select command may include a mask address and a mask value. The mask address indicates to the tags receiving the command, such as tag 110-K, an address that is to be used in a comparison with the mask value. In one embodiment, the mask address may indicate sensor data.

Tag 110-K may be associated with multiple sensors. For example, tag 110-K may have at least one sensor block integrated into its core RFID circuitry, have another sensor block on the tag but outside the RFID core circuitry, etc. Data provided by these sensors, such as temperature, humidity, pressure, velocity, and the like, may be stored at different memory locations. Sensor data may be mapped into physical memory locations or outside physical memory.

Accordingly, the address indicated by the mask address may include sensor data, which is to be used in a comparison with the mask value as described below.

FIG. 12B illustrates a mask value being compared to sensor data located at a mask address in tag memory.

In this example embodiment, the mask value received with the Select command is first saved into memory element 1261. Tag 110-K includes addresses 1260 some of which may be mapped into memory, with others mapped outside of memory.

The sensor data to be used in the comparison is located at memory address 1265 as indicated by the mask address. In operation 1250, tag 110-K compares the sensor data at memory address 1265 with the mask value at memory address 1261 and determines whether they match.

In another embodiment, tag 110-K may perform the comparison as it receives the Select command, without first saving the mask value into memory element 1261.

In yet another embodiment, tag 110-K may derive a processed value from the sensor data at memory address 1265 and compare the processed value to the mask value.

Depending on a result of the comparison (i.e. if there is a match or not), a flag is set at operation 1270. The flag may be a value stored at another memory location, may be a state machine value, and the like.

Tag 110-K may then respond to one or more additional commands from the reader based on the status of the flag set at operation 1270, thereby enabling the reader to select tags with particular flag values.

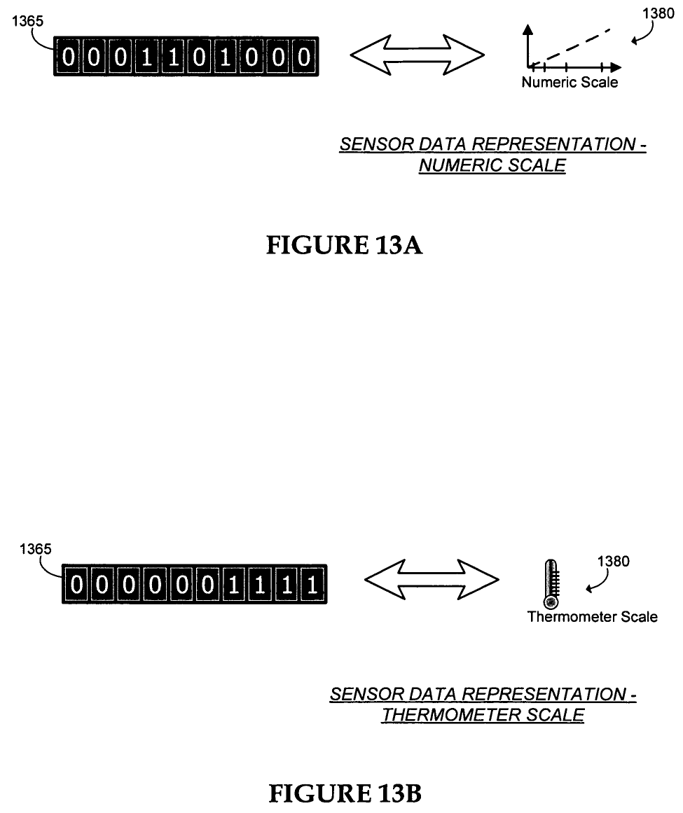

FIGS. 13A and 13B illustrate sensor data represented on an example numeric scale and an example thermometer scale, respectively.

In some embodiments, sensor data 1365 may be represented in binary numeric code. The tag may count the sensor data in binary and store the sensor data 1365 such that the quantified property reflected by the sensor data is determined in a binary scale 1380.

In other embodiments, the tag may use a thermometer scale (1380) to store sensor data 1365. For example, if the quantified property is received signal strength, sensor data 1365 may include a number of “1” values, starting with a rightmost “1” value, corresponding to the signal strength on a thermometer scale.

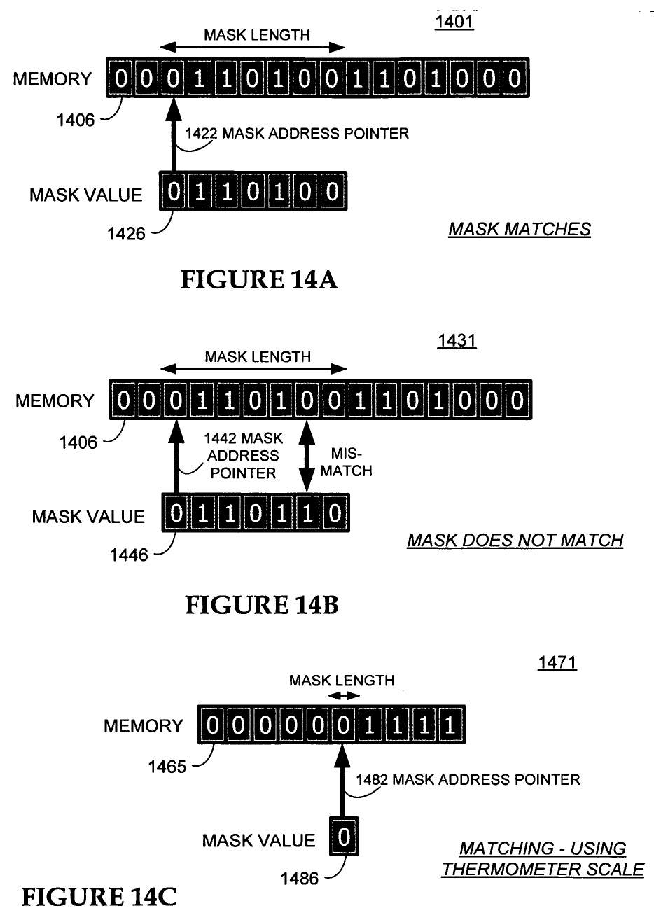

FIGS. 14A and 14B show examples of mask matching and mask not-matching based on comparing the mask value with sensor data mapped into memory.

Memory 1406 in diagram 1401 includes sensor data in binary format. The sensor data may be represented according to a logarithmic, linear, or other scale. A Select command transmitted by the reader may represent the mask address in a number of ways, such as by a mask address pointer and mask length. The mask address pointer may specify the start of the mask address, and the mask length may specify the length of the mask value located at the starting address.

In example diagram 1402, mask value 1426 has a mask length of seven bits. Mask address pointer 1422 indicates that the sensor data to be compared begins at the third bit of memory 1406.

During operation, the tag processing block reads memory 1406 beginning from the third bit as indicated by mask address pointer 1422, and reads the number of bits specified by the mask length parameter. The processing block compares the contents of that portion of memory 1406 to mask value 1426.

In example diagram 1401, mask value 1426 matches the indicated portion of memory 1406, so the processing block sets a flag accordingly.

Example diagram 1431 shows the same memory (1406) and mask address pointer 1442. This time, mask value 1446 has slightly differing contents. A value of the sixth bit in mask value 1446 is different from mask value 1426. Therefore, there is no match in example diagram 1431, and the flag is set to a different value by the processing block.

FIG. 14C shows an example of comparing a mask value using the thermometer scale of FIG. 13B, where a single-bit mask can select all tags whose sensor data exceeds a value and deselect all others, or vice versa.

Memory 1406 of FIGS. 14A and 14B include a non-thermometer scale representation of the sensor data. In contrast, memory 1465 of example diagram 1471 includes a thermometer scale representation of the sensor data.

As described previously, a thermometer scale representation includes a number of bits set to “1” beginning with the rightmost bit. A ratio of the number of bits set to “1” to the total number of bits in the memory range corresponds to a normalized value of the quantified property such as temperature, signal strength, humidity, and the like.

Using a thermometer scale representation, a Select command can specify tags whose quantified property exceeds (or is less than) a threshold using a single bit mask. In example diagram 1471, mask value 1486 is a single bit long and includes value “0”. Thus, the reader is trying to select a subpopulation of tags based on whether a quantified property mapped into memory has exceeded a threshold value indicated by mask address pointer 1482. The “0” value of the mask matching the indicated bit of memory 1465 means that the quantified property has not reached the threshold yet. The tag can set a flag according to this determination.

If mask value 1486 did not match, the tag would determine that the threshold had been reached, and set the flag accordingly. In other embodiments, other values may be employed for the thermometer scale representation such as starting with bit value “0” instead of “1”, or counting from the leftmost bit instead of the rightmost bit.

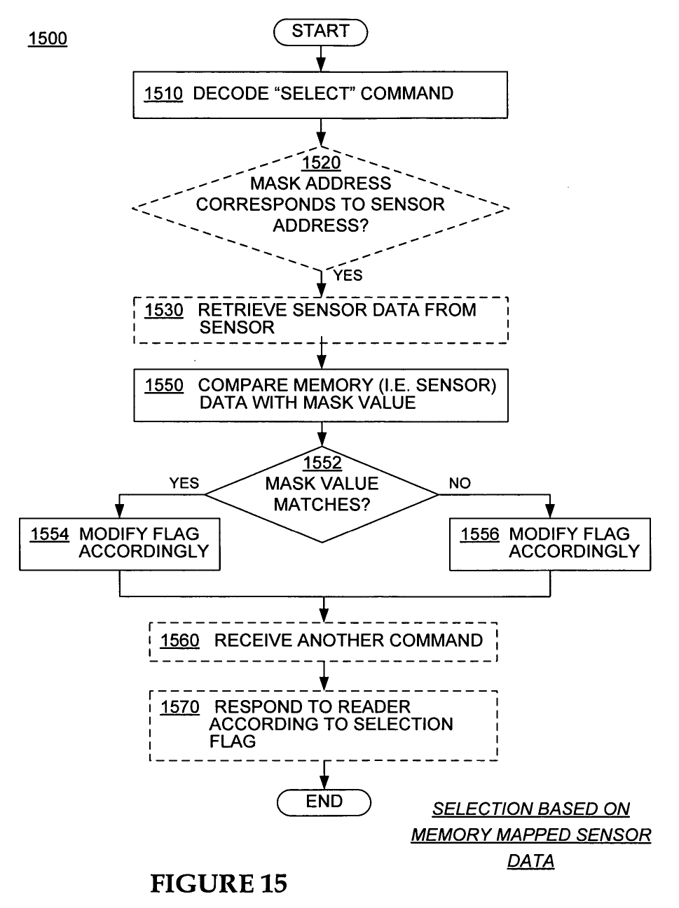

FIG. 15 shows a flowchart for process 1500 of actions performed by an RFID tag, such as RFID tag 110-K of FIG. 1, during selection according to one embodiment.

Process 1500 begins with block 1510 where a tag decodes a Select command from a wave communicated to the tag by a reader. The command may be associated with a mask address and a mask value. For example, the mask address and the mask value may be included in a payload of the command. Processing then proceeds to optional decision block 1520.

At optional decision block 1520 a determination is made whether at least a portion of the mask address corresponds to an address associated with a sensor. The address associated with the sensor may be mapped outside a tag physical memory or to a location of the tag physical memory. If the mask address corresponds to the sensor address, processing advances to optional block 1530.

At optional block 1530, sensor data may be retrieved from the sensor. The sensor data may be retrieved in response to the determination in optional decision block 1520, or in response to the tag transitioning from a state of lacking power to a state of having power, or in response to another event. Processing moves from optional block 1530 to block 1550.

At block 1550, the memory data (i.e. sensor data at the memory location) is compared to the mask value. The sensor data may be directly compared to the mask value, or a processed value that is generated from at least the sensor data may be compared to the mask value. The processed value may be derived by converting the sensor data into a representation on at least one of a thermometer scale, a numeric scale, a threshold scale, and the like. The processed value may also be generated based on a reference value that is decoded from a communication by the reader. Processing then proceeds to decision block 1552.

At decision block 1552, a determination is made whether the mask value matches the memory data or the processed value. If the two match, processing advances to block 1554 where a flag is set accordingly. If there is no match, processing advances to block 1556 where the flag is set to another status accordingly. The flag may be a bit value used by the tag state machine that is set to “0” or “1” according to the result of the comparison.

Processing proceeds from blocks 1554 and 1556 to optional block 1560. At optional block 1560, the tag receives another command from the reader. The other command may include any type of communication including, but not limited to, another Select command, a Query, an access, and the like. Processing advances from optional block 1560 to optional block 1570, where the tag responds to the reader according to the flag selection in one of the block 1554 or 1556. Processing then moves to a calling process for further actions.

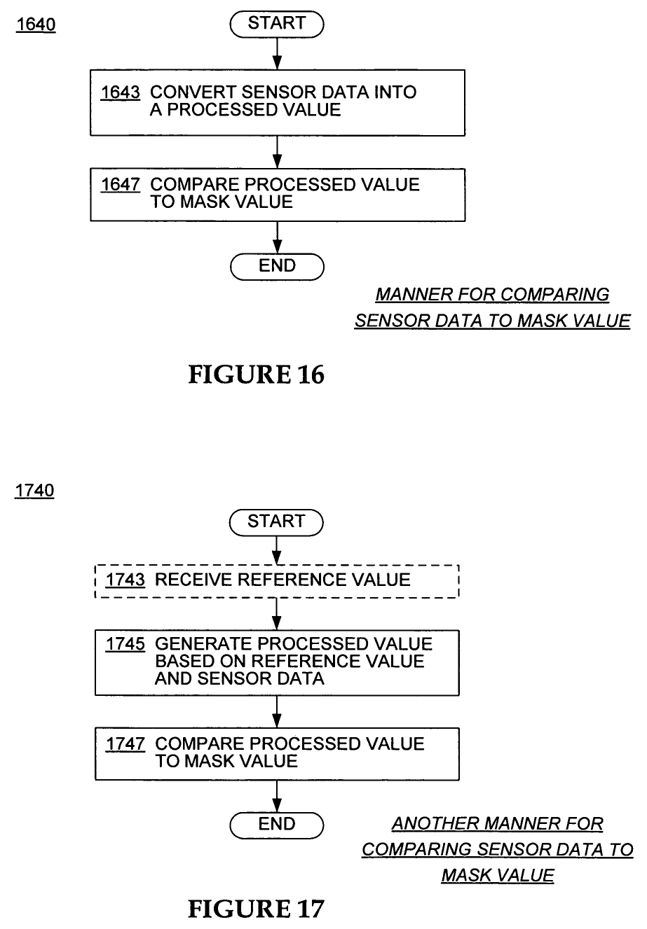

FIG. 16 is a partial flowchart illustrating process 1640 of a manner for comparing sensor data to a mask value in the process of FIG. 15.

Process 1640 follows retrieval of the sensor data from the sensor and begins at block 1643, where the sensor data is converted into a processed value. The processed value may be represented on one of a thermometer scale, a numeric scale, a threshold scale, and the like.

At block 1647, which follows block 1643, the processed value is compared to the mask value. Processing then proceeds to decision block 1552 of process 1500.

FIG. 17 is a partial flowchart illustrating process 1740 of another manner for comparing sensor data to the mask value in the process of FIG. 15.

Process 1740 begins with optional block 1743, where a reference value is received. The reference value may be decoded from a communication by the reader, not necessarily the same communication that includes the mask address and the mask value. Processing then proceeds to block 1745.

At block 1745, the processed value is generated based on the reference value and the sensor data. Processing advances from block 1745 to block 1747.

At block 1747, the processed value is compared to the mask value. Processing then proceeds to decision block 1552 of process 1500.

The operations included in processes 1500, 1640, and 1740 are for illustration purposes. Selecting a tag based on memory-mapped sensor data along with the manners for comparing sensor data to a mask value may be implemented by a similar process with fewer or additional steps.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A radio frequency identification (RFID) tag, comprising:
an antenna that is arranged to receive a modulated wave; and
a processor that is arranged to:
associate with a mask address sensor data from a sensor associated with the tag;
decode from the wave at least one command that is associated with the mask address and a mask value; and
set a selection flag responsive to the command depending on whether the mask value matches a portion of the sensor data from the sensor.

2. The tag of claim 1, wherein the processor is further arranged to:
decode a subsequent command from another wave received by the antenna; and
respond to the subsequent command depending on whether the selection flag is set.

3. The tag of claim 1, wherein the processor is further arranged to:
decode the mask address from the wave.

4. The tag of claim 1, further comprising:
a memory, and
wherein the mask address maps outside the memory.

5. The tag of claim 1, further comprising:
a memory, and
wherein the mask address maps in a location of the memory.

6. The tag of claim 1, wherein the processor is further arranged to:
input the sensor data.

7. The tag of claim 1, wherein the processor is further arranged to:
input the sensor data in response to the command.

8. The tag of claim 1, wherein the processor is further arranged to:
input the sensor data in response to the tag transitioning from a state of lacking power to a state of having power.

9. The tag of claim 1, wherein the processor is further arranged to:
store the sensor data in a memory of the tag.

10. The tag of claim 1, wherein the processor is further arranged to:
generate a processed value based on at least the sensor data.

11. The RFID tag of claim 10, wherein the processor is further arranged to:
store the processed value in a memory of the tag.

12. The RFID tag of claim 10, wherein
the processed value is represented on at least one of a thermometer scale, a numeric scale, and a threshold scale.

13. The tag of claim 10, wherein
the processed value is generated also based on a reference value.

14. The tag of claim 13, wherein
the reference value is stored in a memory of the tag.

15. The tag of claim 13, wherein the processor is further arranged to:
decode the reference value from a wave received by the antenna.

16. The tag of claim 13, wherein
the processed value is generated from a difference between the sensor data and the reference value.

17. The tag of claim 1, wherein the sensor data is at least one of:
a parameter of at least one of the modulated wave and a history of modulated waves;
telemetry information associated with at least one of the tag and an object that is attached to the tag;
environmental information associated with at least one of a temperature, a pressure, a humidity, a light intensity, and a pH level; and
physical information associated with at least one of a velocity, an acceleration, and a power level associated with the RFID tag.

18. A radio frequency identification (RFID) tag, comprising:
a means for associating with a mask address sensor data from a sensor associated with the tag;
a means for receiving a modulated wave;
a means for decoding from the wave at least one command that is associated with the mask address and a mask value; and
a means for setting a selection flag responsive to the command depending on whether the mask value matches a portion of the sensor data.

19. The RFID tag of claim 18, further comprising:
a means for decoding a subsequent command from another received wave; and
a means for responding to the subsequent command depending on whether the selection flag is set.

20. The RFID tag of claim 18, further comprising:
a means for inputting the sensor data; and
a means for storing the sensor data in a memory of the tag.

21. The RFID tag of claim 18, further comprising:
a means for generating a processed value based on at least the sensor data; and
a means for storing the processed value in a memory of the tag.

22. A method for a radio frequency identification (RFID) tag, comprising:
associating with a mask address sensor data from a sensor associated with the tag;
receiving a modulated wave;
decoding from the wave at least one command that is associated with the mask address and a mask value; and
setting a selection flag responsive to the command depending on whether the mask value matches a portion of the sensor data.

23. The method of claim 22, further comprising:
decoding a subsequent command from another received wave; and
responding to the subsequent command depending on whether the selection flag is set.

24. The method of claim 22, further comprising:
decoding the mask address from the wave.

25. The method of claim 22, wherein
the tag has a memory, and
the mask address maps outside the memory.

26. The method of claim 22, wherein
the tag has a memory, and
the mask address maps in a location of the memory.

27. The method of claim 22, further comprising:
inputting the sensor data.

28. The method of claim 22, further comprising:
inputting the sensor data in response to the command.

29. The method of claim 22, further comprising:
inputting the sensor data in response to the tag transitioning from a state of lacking power to a state of having power.

30. The method of claim 22, further comprising:
storing the sensor data in a memory of the tag.

31. The method of claim 22, further comprising:
generating a processed value based on at least the sensor data.

32. The method of claim 31, further comprising:
storing the processed value in a memory of the tag.

33. The method of claim 31, wherein
the processed value is represented on at least one of a thermometer scale, a numeric scale, and a threshold scale.

34. The method of claim 31, wherein
the processed value is generated also based on a reference value.

35. The method of claim 34, wherein
the reference value in stored in a memory of the tag.

36. The method of claim 34, further comprising:
decoding the reference value from a received wave.

37. The method of claim 34, further comprising:
the processed value is generated based on a difference between the sensor data and the reference value.
